(19) United States
(12) Patent Application Publication
(10) Pub. No.: US 2014/0177726 A1
(43) Pub. Date: Jun. 26, 2014

(54) VIDEO DECODING APPARATUS, VIDEO DECODING METHOD, AND INTEGRATED CIRCUIT

(71) Applicant: PANASONIC CORPORATION, OSAKA (JP)

(72) Inventor: Kazunori OKAJIMA, Osaka (JP)

(73) Assignee: PANASONIC CORPORATION, OSAKA (JP)

(21) Appl. No.: 14/191,253

(22) Filed: Feb. 26, 2014

Related U.S. Application Data
(63) Continuation of application No. PCT/JP2012/004154, filed on Jun. 27, 2012.

(30) Foreign Application Priority Data
Sep. 2, 2011 (JP) 2011-192066

(51) Int. Cl. H04N 19/51; H04N 19/583

(52) U.S. Cl. CPC H04N 19/00703; H04N 19/00733
USPC 375/240.16

(57) ABSTRACT

A video decoding apparatus includes: a decoding unit which derives a flag regarding a motion vector from an encoded video stream; a comparing unit which determines whether or not motion vectors of adjacent blocks are equal to each other; a block combining unit which combines the adjacent blocks determined as being equal in motion vector, into one motion compensation block on which motion compensation is to be performed; a motion vector generating unit which generates a motion vector; a reference image obtaining unit which obtains a reference image corresponding to the motion compensation block from reference image data stored in a memory; a motion compensating unit which generates a prediction image corresponding to the motion compensation block; and an adder which reconstructs an image using the prediction image generated by the motion compensating unit.

### CROSS REFERENCE TO RELATED APPLICATION

This is a continuation application of PCT International Application No. PCT/JP2012/004154 filed on Jun. 27, 2012, designating the United States of America, which is based on and claims priority of Japanese Patent Application No. 2011-192066 filed on Sep. 2, 2011. The entire disclosures of the above-identified applications, including the specifications, drawings and claims are incorporated herein by reference in their entirety.

### FIELD

The present disclosure relates to a video decoding apparatus and a video decoding method for decoding an encoded video stream encoded using motion estimation.

### BACKGROUND

In recent years, with the development of multimedia technology, every kind of information such as video, still images, audio, and text is distributed as a digital signal. For video encoding in particular, the video encoding technologies are used as the standards, such as: H.261 and H.263 standardized by the International Telecommunication Union Telecommunication Standardization Sector (ITU-T); and Motion Picture Experts Group (MPEG)-1, MPEG-2, and MPEG-4 standardized by the International Organization for Standardization/the International Electrotechnical Commission (ISO/IEC).

Moreover, H.264 (MPEG-4 AVC) and VP8, for example, have attracted attention in recent years as the encoding methods that have higher compression rates and are capable of extensive applications including mobile data terminals typified by smartphones and network distribution. H.264 (MPEG-4 AVC) is a standard developed by the ITU-T together with the ISO. VP8 is not a standard, but is a manufacturer-specific video encoding specifications developed by Google Inc.

### CITATION LIST

### Patent Literature

### [PTL 1]

Japanese Unexamined Patent Application Publication No. 2005-354673

### [PTL 2]

Re-publication of PCT International Publication No. 2007-055013

### Non Patent Literature

### [NPT 1]

ITU-T (International Telecommunication Union Telecommunication Standardization Sector) recommendation “H.264 (03/10)”, June 2010.

### [NPL 2]

VP8 Data Format and Decoding Guide

### SUMMARY

### Technical Problem

In general, in video encoding, the amount of information is compressed by reducing redundancies in the time direction and the spatial direction.

In inter-picture prediction encoding performed to reduce the redundancy in the time direction, a motion vector is firstly calculated through motion estimation performed on a block-by-block basis with reference to an image preceding or following a current image to be encoded. Next, a prediction image is generated based on a block indicated by the motion vector. Then, the motion vector and a value of difference between the obtained prediction image and the current image are encoded to generate an encoded video stream.

To decode the encoded video stream that is encoded according to the method described above, motion compensation and reconstruction are performed. By motion compensation, the motion vector indicating reference image data on an image previously decoded is decoded and the prediction image calculated based on the motion vector is generated. By reconstruction, an original image is reconstructed by adding the prediction image generated by motion compensation to a difference value obtained from the encoded video stream.

Motion compensation is usually performed on a macroblock-by-macroblock basis, the macroblock having a size of 16×16 pixels. To be more specific, since one or more motion vectors are obtained for each macroblock, a decoding apparatus can reconstruct an image by reading data on an image region indicated by the motion vectors from reference image data (from a frame memory, for example) and adding the read data to a value of difference from an original image obtained from the encoded video stream.

Moreover, the motion vector (referred to as the “MV” hereafter) is not usually encoded as it is. As shown by Equation 1 below, the MV includes a motion vector predictor (referred to as the “PMV” or the “MV predictor” hereafter) and a motion vector difference (referred to as the “MVD” or the “MV difference” hereafter). Thus, the PMV and the MVD are separately encoded.

MV=PMV+MVD Equation 1

In the case of the PMV according to H.264 (see Non Patent Literature (NPL) 1), an adjacent block having the MV to be used or a method of deriving the PMV is predetermined based on the size of a block on which motion compensation is to be performed (this size is also referred to as the macroblock type). Moreover, it is predetermined for the MVD to be encoded into the encoded video stream based on the macroblock type (for example, according to H.264, the MVD is encoded in the case of an inter-macroblock that is not a skip macroblock).

In the case of the PMV according to VP8 (see NPL 2), the encoded video stream includes an encoded flag indicating: which adjacent block has the MV to be used; whether or not the value of the MV is 0; or whether or not the MVD is included in the encoded video stream. Thus, the MVD is encoded in the encoded video stream based on the value of the flag.

It should be obvious that the MV may be encoded as it is in the encoded video stream. Therefore, how the MV is included into the encoded video stream is defined by the corresponding video encoding standard.

Here, a decoding circuit that executes decoding described above is usually configured to temporarily store the decoded image data into an external memory. For this reason, to perform image decoding using motion estimation, the reference image data needs to be read from the external memory.

For example, when MPEG-2 is employed, a macroblock is divided into two regions and motion estimation can be performed for each of the divided regions (hereafter, a region on which motion estimation is to be performed is referred to as a “block” or a “motion compensation block”). Moreover, according to H.264 and VP8, a macroblock can be divided into 16 blocks each having a size of 4×4 pixels. When the macroblock is divided into blocks in this way, the reference image data indicated by the motion vector is read from the external memory for each of the regions corresponding to the divided blocks. As a result of this, when the number of divided blocks is larger, the number of times the memory is accessed is increased. Furthermore, a problem arises that data traffic between the memory and the decoding circuit increases, meaning that the memory band width increases.

Moreover, the motion vector can usually indicate a reference image position. Or more specifically, the motion vector can indicate not only an integer pixel position of the reference image but also a sub-pixel position of the reference image (such as a half pixel position or a quarter pixel position). To calculate a prediction image of a sub-pixel position, filtering needs to be performed using the reference image indicated by the motion vector and peripheral pixels.

For example, in motion compensation performed according to H.264 or VP8, a 6-tap filter may be used (see NPL 1 and NPL 2). Here, FIG. 9 is a diagram showing reference image data used by a 6-tap filter in the case where the size of a block for motion compensation (referred to as the “partition size” hereafter) is four pixels in each of the horizontal and vertical directions (referred to as the “4×4” hereafter).

In the diagram, a cross indicates a prediction pixel calculated after motion compensation, and a circle indicates a pixel necessary for motion compensation performed using the 6-tap filter. To be more specific, for motion compensation performed on a block having the partition size of 4×4 (indicated by the solid line in FIG. 10A), reference image data of 9×9 pixels (indicated by the dashed line in FIG. 10A) is necessary. Similarly, for motion compensation performed on a block having the partition size of 16×16 (indicated by the solid line in FIG. 10B), reference image data of 21×21 pixels (indicated by the dashed line in FIG. 10B) is necessary. Moreover, for motion compensation performed on a block having the partition size of 8×8, reference image data of 13×13 pixels is necessary (a diagram in this case is omitted).

Accordingly, when the partition size is 16×16 for example, reference image data necessary for generating a prediction image for a luminance component is 21×21 pixels in size as shown in FIG. 10B. In this case, the maximum amount of data to be read as the reference image data necessary for generating a prediction image for a luminance component of one macroblock (in the case of one byte per luminance pixel) is 441 (bytes)=21 (pixels)*21 (pixels)*1 (the number of vectors), for each of prediction directions. It should be noted that the amount of data to be read as the reference image data may further increase depending on, for example, a bus width of a bus connected to the external memory and the amount of data for each access. Moreover, note that the amount of data to be read as the reference image data may increase depending on, for example, a bus width of a bus connected to the external memory, the amount of data per access, and AC characteristics of the external memory (such as a Column Address Strobe (CAS) latency and a wait cycle of an SDRAM).

On the other hand, when the partition size is 4×4, a region of 9×9 pixels needs to be read as shown in FIG. 10A. In this case, the maximum amount of data to be read as the reference image data necessary for generating a prediction image for a luminance component of one macroblock is 1296 (bytes)=9 (pixels)*9 (pixels)*16 (the number of vectors), for each of the prediction directions. Thus, the amount of data to be read is larger than in the case where the partition size is 16×16.

To address the problem of the increased amount of reference image data to be read as described above, a video decoding circuit has been proposed (see Patent Literature (PTL) 1 and PTL 2, for example). This video decoding circuit reduces the amount of reference image data to be read, by combining the reference image data necessary for one macroblock into a single two-dimensional data region.

FIG. 11A and FIG. 11B show examples of the reference image data necessary for motion compensation performed according to the above-stated technology. FIG. 11A shows four blocks each included in the same macroblock and having the partition size of 8×8, and also shows motion vectors of the blocks. FIG. 11B shows the reference image data required by the blocks shown in FIG. 11A, in the case where such reference image data is combined into a single image region as indicated by a dashed line 1100. To be more specific, since reference image data items are combined into a single image region, redundant image data does not need to be repeatedly obtained from the external memory (the frame memory) and, therefore, the memory band width can be reduced.

FIG. 12A and FIG. 12B are diagrams showing examples of pixels to be used for motion compensation, intermediate pixels, and output pixels. In general, to calculate a sub-pixel position (such as a half pixel position in an X direction and a half pixel position in a Y direction) by motion compensation, horizontal filtering and vertical filtering are used in combination. By horizontal filtering, 6-tap filtering is implemented in the horizontal direction to calculate the sub-pixel position in the horizontal direction. By vertical filtering, 6-tap filtering is implemented in the vertical direction to calculate the sub-pixel position in the vertical direction using the pixel calculated by horizontal filtering.

The order in which horizontal filtering and vertical filtering are performed, filter coefficients, and rounding are different depending on the video encoding standard (see NPL 1 and NPL 2, for example). FIG. 12A is a diagram showing: pixels (each indicated by a blank circle) necessary for motion compensation in the case where the partition size is 4×4; output pixels (each indicated by a filled square) after horizontal filtering; and output pixels (each indicated by a cross) after motion compensation. FIG. 12B is a diagram showing: pixels (each indicated by a blank circle) necessary for motion compensation in the case where the partition size is 4×8; output pixels (each indicated by a filled square) after horizontal filtering; and output pixels (each indicated by a cross) after motion compensation. Note that, in the present example, horizontal filtering and vertical filtering are performed in this order.

Suppose the case where the prediction image for the luminance component of one macroblock (256 bytes) is to be generated. In this case, when the partition size is 4×4, the number of times (throughput) 6-tap filtering needs to be performed is: 36 times (indicated by the filled squares in FIG. 12A)=4 (pixels)*9 (pixels) in horizontal filtering; and 16 times (indicated by the crosses in FIG. 12A)=4 (pixels)*4 (pixels) in vertical filtering. In other words, 6-tap filtering needs to be performed 832 times=(36+16)*16 (the number of partitions) for one macroblock.

On the other hand, when the partition size is 4×8, horizontal filtering needs to be performed 52 times (indicated by the filled squares in FIG. 12B)=4 (pixels)*13 (pixels) and vertical filtering needs to be performed 32 times (indicated by the crosses in FIG. 12B)=4 (pixels)*8 (pixels). In other words, 6-tap filtering needs to be performed 672 times=(52+32)*8 (the number of partitions) for one macroblock. Thus, the number of times filtering needs to be performed is reduced as compared with the case where the partition size is 4×4. Similarly, when the partition size is 16×16, horizontal filtering needs to be performed 336 times=16 (pixels)*21 (pixels) and vertical filtering needs to be performed 256 times=16 (pixels)*16 (pixels). In other words, 6-tap filtering needs to be performed 592 times=(336+256)*1 (the number of partitions) for one macroblock. Thus, the number of times filtering needs to be performed is further reduced.

More specifically, when the partition size is smaller, the number of times filtering needs to be performed increases. This has caused a problem of performance degradation.

Here, processing performance can be increased by a circuit having a configuration whereby a plurality of pixels can be outputted at one time in the horizontal or vertical direction through filtering. For example, when the partition size is 4×4 (as in FIG. 12A) and 8 pixels can be outputted at the same time through 6-tap filtering, horizontal filtering may be performed 9 times and vertical filtering may be performed 4 times. More specifically, the number of times filtering is performed is 208 times=(9+4)*16 (the number of partitions) for one macroblock. When the partition size is 4×8 (as in FIG. 12B), horizontal filtering may be performed 13 times and vertical filtering may be performed 4 times. More specifically, the number of times filtering is performed is 136 times=(13+4)*8 (the number of partitions) for one macroblock.

Thus, even in this case, when the partition size is smaller, the number of times filtering needs to be performed increases. This leads to a problem of performance degradation.

As in the case of the technology described above, the amount of reference image data to be read can be reduced by combining the reference images necessary for one macroblock into one image region. However, motion compensation, or more specifically, filtering, needs to be performed for each partition. In addition, when the partition size is smaller, the processing load for filtering increases. This results in degradation of processing performance, which may in turn interfere with acceleration in decoding. Moreover, an increase in the operating frequency for acceleration may cause a problem of increased power consumption.

The present disclosure is conceived in view of the aforementioned problem, and has an object to provide a video decoding apparatus and a video decoding method capable of implementing motion compensation at high speed with low power consumption by reducing the number of pixels to be read as reference image data from a frame memory when decoding an encoded stream encoded using motion estimation.

### Solution to Problem

A video decoding apparatus according to an aspect of the present disclosure decodes an encoded video stream encoded using motion estimation performed on a block-by-block basis. To be more specific, the video decoding apparatus includes: a decoding unit which decodes the encoded video stream to derive a flag regarding a motion vector, the flag indicating one of (i) a prediction direction indicating that the motion vector is equal to a motion vector of an adjacent block, (ii) that the motion vector is 0, and (iii) that difference information on the motion vector is encoded in the encoded video stream; a motion vector comparing unit which determines whether or not a plurality of the motion vectors of adjacent blocks are equal to each other, using a plurality of the flags regarding the motion vectors of the adjacent blocks, the flags being derived by the decoding unit; a block combining unit which combines the adjacent blocks determined by the motion vector comparing unit as being equal in motion vector, into one motion compensation block on which motion compensation is to be performed; a motion vector generating unit which generates a motion vector based on the flag regarding the motion vector; a reference image obtaining unit which obtains, based on the motion vector generated by the motion vector generating unit, a reference image corresponding to the motion compensation block from reference image data previously decoded and stored into a memory; a motion compensating unit which performs motion compensation using the reference image obtained by the reference image obtaining unit, to generate a prediction image corresponding to the motion compensation block; and a reconstructing unit which reconstructs an image using the prediction image generated by the motion compensating unit.

With this, when it is determined based on the flags regarding the motion vectors that the adjacent blocks are equal in motion vector, the blocks are combined. Then, the reference image data can be obtained for each combined motion compensation block.

Accordingly, the number of pixels to be read as the reference image data from the frame memory is reduced, and the blocks for motion compensation are largely combined. Hence, motion compensation can be implemented at high speed with low power consumption.

Moreover, the block combining unit may set a motion compensation block determined by the motion vector comparing unit as being different from the adjacent block in motion vector, as an independent motion compensation block.

With this, even when the adjacent blocks are different in motion vector, the reference image data can be obtained for each independent motion compensation block.

Accordingly, the number of pixels to be read as the reference image data from the frame memory is reduced, and the blocks for motion compensation are largely combined. Hence, motion compensation can be implemented at high speed with low power consumption.

Furthermore, the prediction direction indicated by the flag regarding the motion vector may indicate that a block associated with the flag is equal in motion vector to an above adjacent block or a left adjacent block.

With this, whether or not the adjacent blocks are equal in motion vector can be easily determined simply based on the flag indicating the prediction direction of the motion vector, that is, the flag indicating that the current block is equal in motion vector to the above or left adjacent block. In the case where the adjacent blocks are equal in motion vector, the adjacent blocks are combined. Then, the reference image can be obtained for each combined block.

Accordingly, the number of pixels to be read as the reference image data from the frame memory is reduced, and the blocks for motion compensation are largely combined. Hence, motion compensation can be implemented at high speed with low power consumption.

Moreover, each of the blocks to be compared by the motion vector comparing unit and each of the blocks to be combined by the block combining unit may be 4 pixels by 4 pixels or 8 pixels by 8 pixels in size.

With this, whether or not the adjacent blocks are equal in motion vector is determined based on the flags regarding the prediction directions of the motion vectors of the adjacent blocks each having the size of 4×4 pixels or 8×8 pixels. In the case where the adjacent blocks are equal in motion vector, the adjacent blocks are combined. Then, the reference image can be obtained for each combined motion compensation block.

Accordingly, the number of pixels to be read as the reference image data from the frame memory is reduced, and the blocks for motion compensation are largely combined. Hence, motion compensation can be implemented at high speed with low power consumption.

Furthermore, the blocks to be compared by the motion vector comparing unit may be included in the same macroblock.

With this, whether or not the adjacent blocks are equal in motion vector is determined based on the flags regarding the motion vectors of the adjacent blocks in the macroblock. In the case where the adjacent blocks are equal in motion vector, the adjacent blocks are combined. Then, the reference image can be obtained for combined motion compensation block.

Accordingly, the number of pixels to be read as the reference image data from the frame memory is reduced, and the blocks for motion compensation are largely combined. Hence, motion compensation can be implemented at high speed with low power consumption.

Moreover, the motion vector comparing unit may determine, for each of the blocks, whether or not the block is equal in motion vector to an above adjacent block, a left adjacent block, or an upper-left adjacent block.

With this, when it is determined, based on the flag regarding the motion vector of the above adjacent block, the left adjacent block, or the upper-left adjacent block, that the adjacent blocks are equal in motion vector, the adjacent blocks are combined. Then, the reference image can be obtained for each combined block.

Accordingly, the number of pixels to be read as the reference image data from the frame memory is reduced, and the blocks for motion compensation are largely combined. Hence, motion compensation can be implemented at high speed with low power consumption.

Furthermore, when the flags regarding the motion vectors of two adjacent blocks to be compared by the motion vector comparing unit indicate that the two blocks are equal in motion vector to a motion compensation block included in a macroblock adjacent to the two blocks, the motion vector comparing unit may determine that the motion vectors of the two blocks are equal to each other.

With this, the motion vector of the motion compensation block in the adjacent macroblock is used by the motion vector comparing unit. Thus, when it is determined with reference to the motion vector of the adjacent macroblock that the adjacent blocks are equal in motion vector to the adjacent macroblock, the adjacent blocks are combined. Then, the reference image can be obtained for each combined blocks.

Accordingly, the number of pixels to be read as the reference image data from the frame memory is reduced, and the blocks for motion compensation are largely combined. Hence, motion compensation can be implemented at high speed with low power consumption.

Moreover, the motion compensation block included in the macroblock adjacent to the two blocks may be 16 pixels by 16 pixels or 8 pixels by 8 pixels in size.

With this, when the size of the motion compensation block in the adjacent macroblock is 16×16 pixels or 8×8 pixels, the motion vector comparing unit uses the macroblock. Thus, when it is determined with reference to the motion vector of the motion compensation block in the adjacent macroblock that the adjacent blocks are equal in motion vector to the motion compensation block in the adjacent macroblock, the adjacent blocks are combined. Then, the reference image can be obtained for each combined block.

Accordingly, the number of pixels to be read as the reference image data from the frame memory is reduced, and the blocks for motion compensation are largely combined. Hence, motion compensation can be implemented at high speed with low power consumption.

Furthermore, the encoded video stream may be encoded according to VP8.

With this, when VP8 is employed, the motion vector comparing unit uses the flag regarding the motion vector. Thus, when it is determined that the adjacent blocks are equal in motion vector, the adjacent blocks are combined. Then, the reference image data can be obtained for each combined block.

Accordingly, the number of pixels to be read as the reference image data from the frame memory is reduced, and the blocks for motion compensation are largely combined. Hence, motion compensation can be implemented at high speed with low power consumption.

A video decoding apparatus according to another aspect of the present disclosure decodes an encoded video stream encoded using motion estimation performed on a block-by-block basis. To be more specific, the video decoding apparatus includes: a decoding unit which decodes a difference value of a motion vector from the encoded video stream; a vector predictor calculating unit which calculates a vector predictor indicating a prediction value of the motion vector; a motion vector generating unit which generates a motion vector by adding the vector predictor calculated by the vector predictor calculating unit to the difference value of the motion vector decoded by the decoding unit; a motion vector comparing unit which compares the motion vector generated by the motion vector generating unit with motion vectors of adjacent blocks to determine whether or not the motion vector is equal to the motion vectors of the adjacent blocks; a block combining unit which combines the blocks determined by the motion vector comparing unit as being equal in motion vector, into one motion compensation block on which motion compensation is to be performed; a reference image obtaining unit which obtains, based on the motion vector generated by the motion vector generating unit, a reference image corresponding to the motion compensation block from reference image data previously decoded and stored into a memory; a motion compensating unit which performs motion compensation using the reference image obtained by the reference image obtaining unit, to generate a prediction image corresponding to the motion compensation block; and a reconstructing unit which reconstructs an image using the prediction image generated by the motion compensating unit.

With this, when the adjacent motion compensation blocks are equal in motion vector, these blocks are combined. Then, the reference image data can be obtained for each combined motion compensation block.

Accordingly, the number of pixels to be read as the reference image data from the frame memory is reduced, and the blocks for motion compensation are largely combined. Hence, motion compensation can be implemented at high speed with low power consumption.

A video decoding method according to an aspect of the present disclosure is a method of decoding an encoded video stream encoded using motion estimation performed on a block-by-block basis. To be more specific, the video decoding method includes: decoding the encoded video stream to derive a flag regarding a motion vector, the flag indicating one of (i) a prediction direction indicating that the motion vector is equal to a motion vector of an adjacent block, (ii) that the motion vector is 0, and (iii) that difference information on the motion vector is encoded in the encoded video stream; determining whether or not a plurality of the motion vectors of adjacent blocks are equal to each other, using a plurality of the flags regarding the motion vectors of the adjacent blocks, the flags being derived in the decoding; combining the adjacent blocks determined in the comparing as being equal in motion vector, into one motion compensation block on which motion compensation is to be performed; generating a motion vector based on the flag regarding the motion vector; obtaining, based on the motion vector generated in the generating, a reference image corresponding to the motion compensation block from reference image data previously decoded and stored into a memory; performing motion compensation using the reference image obtained in the obtaining, to generate a prediction image corresponding to the motion compensation block; and reconstructing an image using the prediction image generated in the performing.

With this, when it is determined, based on the flags indicating the prediction directions of the motion vectors, that the adjacent blocks are equal in motion vector, the blocks are combined. Then, the reference image data can be obtained for each combined block.

Accordingly, the number of pixels to be read as the reference image data from the frame memory is reduced, and the blocks for motion compensation are largely combined. Hence, motion compensation can be implemented at high speed with low power consumption.

An integrated circuit according to an aspect of the present disclosure decodes an encoded video stream encoded using motion estimation performed on a block-by-block basis. To be more specific, the integrated circuit includes: a decoding unit which decodes the encoded video stream to derive a flag regarding a motion vector, the flag indicating one of (i) a prediction direction indicating that the motion vector is equal to a motion vector of an adjacent block, (ii) that the motion vector is 0, and (iii) that difference information on the motion vector is encoded in the encoded video stream; a motion vector comparing unit which determines whether or not a plurality of the motion vectors of adjacent blocks are equal to each other, using a plurality of the flags regarding the motion vectors of the adjacent blocks, the flags being derived by the decoding unit; a block combining unit which combines the adjacent blocks determined by the motion vector comparing unit as being equal in motion vector, into one motion compensation block on which motion compensation is to be performed; a motion vector generating unit which generates a motion vector based on the flag regarding the motion vector; a reference image obtaining unit which obtains, based on the motion vector generated by the motion vector generating unit, a reference image corresponding to the motion compensation block from reference image data previously decoded and stored into a memory; a motion compensating unit which performs motion compensation using the reference image obtained by the reference image obtaining unit, to generate a prediction image corresponding to the motion compensation block; and a reconstructing unit which reconstructs an image using the prediction image generated by the motion compensating unit.

With this, when it is determined, based on the flags indicating the prediction directions of the motion vectors, that the adjacent blocks are equal in motion vector, the blocks are combined. Then, the reference image data can be obtained for each combined block.

Accordingly, the number of pixels to be read as the reference image data from the frame memory is reduced, and the blocks for motion compensation are largely combined. Hence, motion compensation can be implemented at high speed with low power consumption.

### Advantageous Effects

As described, the video decoding apparatus according to the present disclosure is capable of reducing the memory band width and also reducing the throughput in motion compensation by combining the blocks that are units of motion compensation. As a result, decoding performance can be increased and decoding processing can be performed at higher speed. Moreover, the reduction in the throughput results in lower power consumption.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a block diagram showing a configuration of a video decoding apparatus according to Embodiment 1.

FIG. 2A is a diagram that explains a flag regarding a motion vector and shows that the motion vector is equal to the motion vector of the left adjacent block.

FIG. 2B is a diagram that explains a flag regarding a motion vector and shows that the motion vector is equal to the motion vector of the above adjacent block.

FIG. 2C is a diagram that explains a flag regarding a motion vector and shows that the motion vector is 0.

FIG. 2D is a diagram that explains a flag regarding a motion vector and shows that motion vector data is included in an encoded video stream.

FIG. 3A is a diagram showing an example of flags regarding motion vectors of blocks included in a macroblock.

FIG. 3B is a diagram showing a result of combining the blocks shown in FIG. 3A.

FIG. 3C is a diagram showing an example of flags regarding motion vectors of blocks included in a macroblock.

FIG. 3D is a diagram showing a result of combining the blocks shown in FIG. 3C.

FIG. 3E is a diagram showing a result of further combining the blocks shown in FIG. 3D.

FIG. 3F is a diagram showing a result of further combining the blocks shown in FIG. 3E.

FIG. 4 is a flowchart of prediction image generation according to Embodiment 1.

FIG. 5A is a diagram showing a positional relationship among blocks included in a partition having the size of 8×8 pixels.

FIG. 5B shows a list of the cases where the blocks shown in FIG. 5A are combinable.

FIG. 5C shows a list of the cases where the blocks shown in FIG. 5A are combinable.

FIG. 6A is a diagram showing an example of flags regarding motion vectors of blocks included in a macroblock.

FIG. 6B is a diagram showing a result of combining the blocks shown in FIG. 6A.

FIG. 6C is a diagram showing a result of further combining the blocks shown in FIG. 6B.

FIG. 7A is a diagram showing a positional relationship between blocks included in a partition having the size of 8×8 and adjacent macroblocks.

FIG. 7B shows a list of the cases where the blocks shown in FIG. 7A are combinable.

FIG. 7C shows a list of the cases where the blocks shown in FIG. 7A are combinable.

FIG. 8 is a flowchart of prediction image generation according to Embodiment 2.

FIG. 9 is a diagram explaining motion compensation performed using a 6-tap filter.

FIG. 10A is a diagram showing an example of reference image data necessary for motion compensation performed on a block having the partition size of 4×4.

FIG. 10B is a diagram showing an example of reference image data necessary for motion compensation performed on a block having the partition size of 16×16.

FIG. 11A is a diagram showing four blocks each having the partition size of 8×8 and also showing motion vectors of the blocks.

FIG. 11B is a diagram showing reference image data required by the blocks shown in FIG. 11A.

FIG. 12A is a diagram showing pixels necessary for motion compensation performed on a block having the partition size of 4×4, intermediate pixels, and output pixels.

FIG. 12B is a diagram showing pixels necessary for motion compensation performed on a block having the partition size of 4×8, intermediate pixels, and output pixels.

### DESCRIPTION OF EMBODIMENTS

The following is a description of embodiments according to the present disclosure, with reference to the drawings.

### Embodiment 1

A video decoding apparatus according to Embodiment 1 of the present disclosure is described as follows.

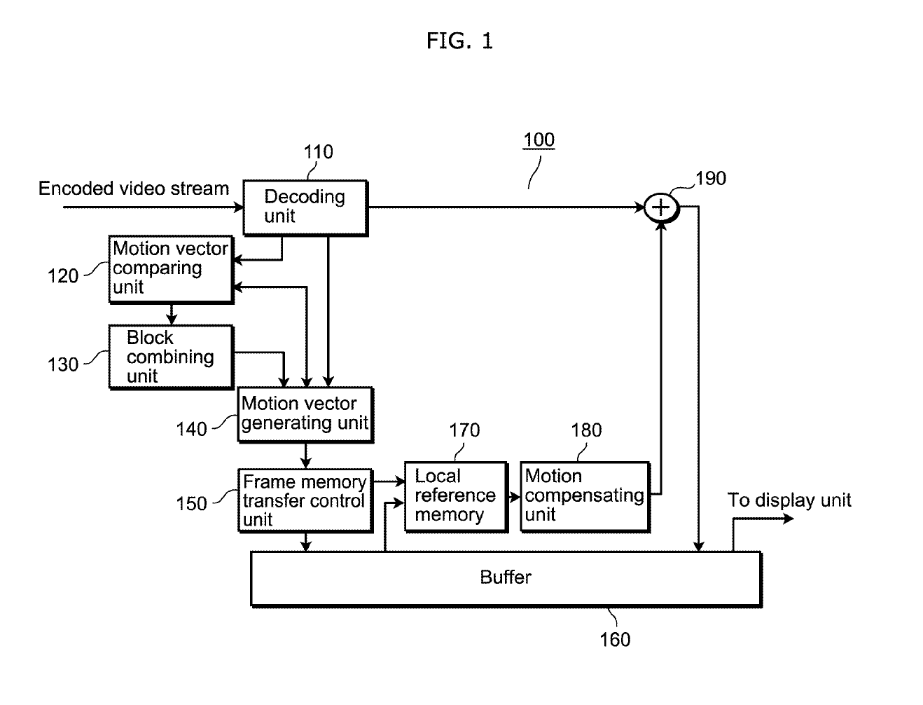

FIG. 1 is a block diagram showing a configuration of a video decoding apparatus 100 according to Embodiment 1 of the present disclosure.

As shown in FIG. 1, the video decoding apparatus 100 includes a decoding unit 110, a motion vector comparing unit 120, a block combining unit 130, a motion vector generating unit 140, a frame memory transfer control unit 150, a buffer 160, a local reference memory 170, a motion compensating unit 180, and an adder (a reconstructing unit) 190.

The decoding unit 110 decodes an encoded video stream inputted into the decoding unit 110. Then, the decoding unit 110 outputs a flag regarding a motion vector, motion vector data, and a value of difference between a current image to be encoded and a prediction image (this image difference is referred to as the “residual image” hereafter). Moreover, the decoding unit 110 outputs the flag regarding the motion vector and the motion vector data to the motion vector comparing unit 120 and the motion vector generating unit 140, and also outputs the residual image to the adder 190.

Here, the flag regarding the motion vector refers to a flag indicating: a prediction direction indicating that the current motion vector is equal to the motion vector of an adjacent block; that the motion vector is 0; or that the motion vector data is included in the encoded video stream. The flag is stored in the encoded video stream for each block.

Moreover, the motion vector data refers to a difference value of the motion vector or the motion vector itself. Here, note that this motion vector data may be stored in the encoded video stream only when the flag regarding the motion vector indicates that the motion vector data is included in the encoded video stream.

When receiving the flag regarding the motion vector from the decoding unit 110, the motion vector generating unit 140 generates a motion vector of a current block to be decoded, using the motion vector of an adjacent block. Moreover, when receiving the difference value of the motion vector, the motion vector generating unit 140 adds, to the difference value of the motion vector, the motion vector of the adjacent block or a prediction MV calculated from the motion vector of the adjacent block. As a result, the motion vector of the current block is generated.

The motion vector comparing unit 120 compares the flag regarding the motion vector received from the decoding unit 110 or the motion vector generating unit 140 with flags regarding motion vectors of adjacent blocks. Then, the motion vector comparing unit 120 determines whether or not the motion vectors of the adjacent blocks are equal to each other and outputs a result of the determination to the block combining unit 130.

When the result of the comparison is received and the adjacent blocks are equal in motion vector, the block combining unit 130 decides to combine these adjacent blocks into a motion compensation block having a size corresponding to a unit of motion compensation (referred to as the “partition size” hereafter). Then, the block combining unit 130 outputs this result to the motion vector generating unit 140. On the other hand, the block combining unit 130 decides to set a block different in motion vector from any of the adjacent blocks, as an independent motion compensation block. Then, the block combining unit 130 outputs this result to the motion vector generating unit 140.

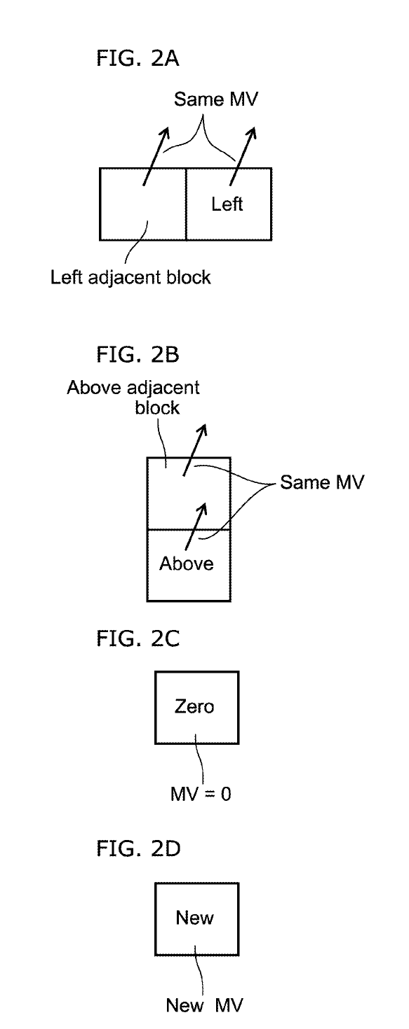

Next, the flag regarding the motion vector is described with reference to FIG. 2A to FIG. 2D.

When the encoded video stream includes the flag regarding the motion vector for each block having the partition size (such as in the case of VP8), the flag is classified into one of four types (indicated as “Left”, “Above”, “Zero”, and “New”) as shown in FIG. 2A to FIG. 2D. Here, the flag regarding the motion vector as mentioned above is described merely as an example, and this example is not intended to be limiting. For example, the flag may indicate that the current motion vector is equal to the motion vector of the upper-left or upper-right adjacent block. Or, the flag may indicate that the current motion vector is equal to the motion vector of the block positioned at least two blocks away from the current block. Moreover, according to the video encoding standards, such as H.264, a prediction direction of a motion vector can be calculated from an encoded video stream. On this account, FIG. 2A to FIG. 2D are not intended to be limiting.

The block described as “Left” in FIG. 2A indicates that the motion vector (referred to as the “MV” hereafter) of this block is equal to the motion vector of the left adjacent block. The block described as “Above” in FIG. 2B indicates that the MV of this block is equal to the MV of the above adjacent block. The block described as “Zero” in FIG. 2C indicates that the MV of this block is 0. Here, it should be obvious that, when the MV is 0, this MV may be equal to the MV of an adjacent block.

The block described as “New” in FIG. 2D indicates that the encoded video stream includes a new MV or a value of difference from the prediction MV calculated from the MV of the decoded neighboring block. More specifically, the MV of the current block to be encoded is different from any of the MVs of the adjacent blocks. It should be noted that the method of deriving a prediction MV from an MV of a neighboring block is predetermined according to the video encoding standard and is not described in detail here (see H.264 or VP8, for example).

As described, since the flag regarding the motion vector is encoded and included into the encoded video stream, the amount of encoded information regarding the motion vector can be easily reduced.

Moreover, when the partition size of the adjacent block is different from that of the current block (such as when the partition size of the current block is 8×8 pixels whereas the partition size of the adjacent block is 4×4 pixels), the adjacent block can be considered to include two blocks each having the partition size of 4×4 pixels. When the adjacent block includes prediction MV candidates in this way, the corresponding video encoding standard defines, for example, whether one of the candidates is to be used or whether the average of the candidates is to be used. Furthermore, it is predetermined, for example, that an adjacent block outside the region of the picture is replaced with a certain value (such as 0) and is not to be used as a prediction MV candidate. Similarly, it is predetermined, for example, that an adjacent block in an intra macroblock where inter prediction is not performed is replaced with a certain value (such as 0) and is not to be used as a prediction MV candidate.

To be more specific, the motion vector generating unit 140 generates the motion vector of the current block to be decoded, using the motion vector of the adjacent block specified by the flag regarding the motion vector that is received from the decoding unit 110. Moreover, suppose that a value of difference from the prediction MV is necessary in addition to the flag regarding the motion vector (as in the case shown in FIG. 2D). In this case, the motion vector generating unit 140 receives the decoded difference value of the motion vector from the decoding unit 110 and generates the motion vector by adding the prediction MV to the difference value.

The frame memory transfer control unit 150 transfers the following data from the buffer 160 to the local reference memory 170. That is, the data to be transferred includes a reference image region indicated by the generated motion vector and pixels necessary for motion compensation (pixels necessary for prediction image generation), for each motion compensation block having the partition size obtained as a result of combining by the block combining unit 130.

The motion compensating unit 180 obtains a prediction image for each motion compensation block from data stored in the local reference memory 170, and outputs the prediction image to the adder 190. The adder 190 adds the residual image outputted from the decoding unit 110 to the prediction image obtained from the motion compensating unit 180, and outputs the result to the buffer 160. After this, the decoded image data is outputted from the buffer 160 to a display unit (not illustrated).

It should be noted that the residual image outputted from the decoding unit 110 is calculated by performing inverse quantization on coefficient data of the frequency component decoded by the decoding unit 110 (such as DCT coefficients) and then transforming the result into pixel data (by, for example, inverse transform or inversed discrete cosine transform (IDCT)). Moreover, in the case of an I picture or an intra macroblock where a temporally-different reference image is not used, a prediction image can be calculated through intra prediction.

Furthermore, although not illustrated in FIG. 1, deblocking filtering defined by the video encoding standards such as H.264 and VP8 may be performed on a macroblock boundary or a block boundary after the addition processing performed by the adder 190. The buffer 160 may be configured with an external memory or an internal memory.

Next, the motion vector comparing unit 120 is described. The motion vector comparing unit 120 compares the motion vectors, using the flag regarding the motion vector that is outputted from the decoding unit 110 (the details are described above with reference to FIG. 2A to FIG. 2D) and the flags of the motion vectors of the adjacent blocks. Here, the flags regarding the motion vectors of the adjacent blocks may be held by the motion vector comparing unit 120 or by the motion vector generating unit 140.

The motion vector comparing unit 120 compares the motion vectors based on the flags regarding the motion vectors of the adjacent blocks. Then, when the adjacent blocks are equal in motion vector, the motion vector comparing unit 120 combines the blocks having the same motion vector into a motion compensation block having a new partition size for motion compensation.

For example, when the partition size is 4×4 and the flag regarding the motion vector indicates “Above”, the above adjacent block (having the partition size of 4×4 for example) and the current block have the same motion vector. Thus, these blocks are combined into a motion compensation block having the partition size of 4×8. Then, the frame memory transfer control unit 150 obtains a reference image corresponding to the motion compensation block having the new combined partition size. Moreover, the motion compensating unit 180 generates a prediction image, by performing motion compensation on the motion compensation block using the obtained reference image.

As described, since the blocks having the same motion vector are combined into one motion compensation block having a larger partition size for motion compensation, the memory transfer size can be reduced as compared with the case where the reference image is obtained corresponding to a smaller partition size before the combining. Moreover, since motion compensation is performed in a larger partition size, the throughput in motion compensation can be reduced.

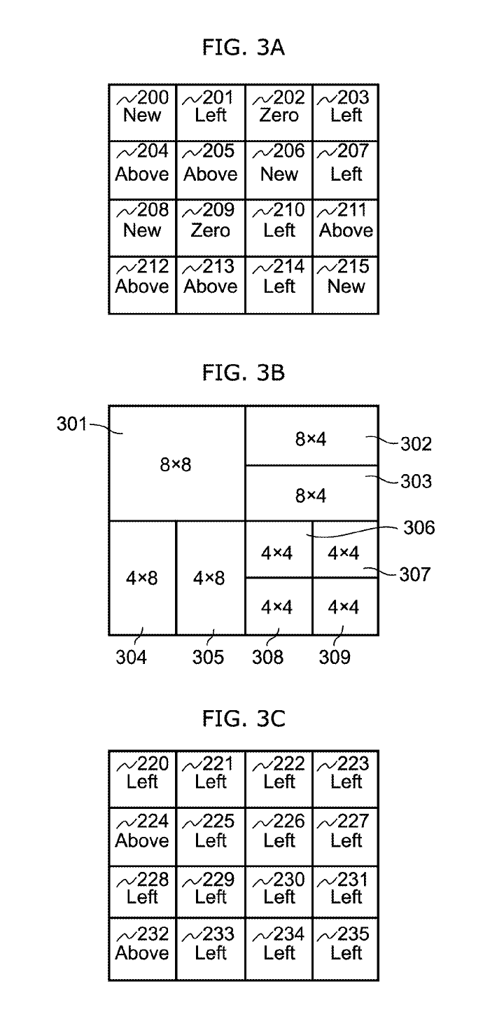

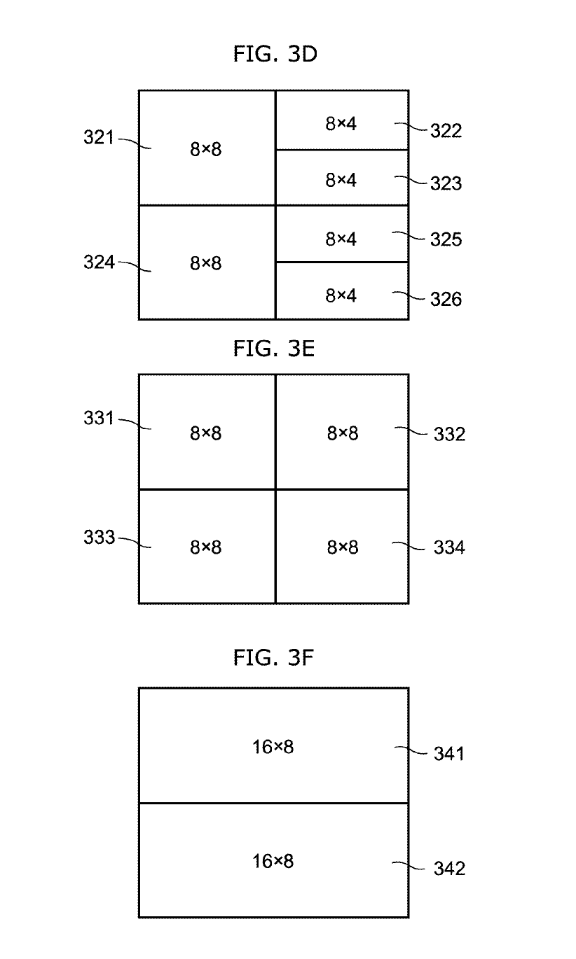

Each of FIG. 3A and FIG. 3B is a diagram showing an example of block combining according to Embodiment 1 of the present disclosure. FIG. 3A shows the case, as an example, where the partition size of each block included in one macroblock is 4×4. In FIG. 3A, a flag regarding a motion vector is described for each of the blocks.

To be more specific, each of the flags of blocks 200, 206, 208, and 215 is “New (indicating that the MV is separately present as in the case shown in FIG. 2D)”. Moreover, each of the flags of blocks 201, 203, 207, 210, and 214 is “Left (indicating that the MV is equal to the MV of the left adjacent block as in the case shown in FIG. 2A)”. Furthermore, each of the flags of blocks 202 and 209 is “Zero (indicating that the MV is 0 as in the case shown in FIG. 2C)”. Moreover, each of the flags of blocks 204, 205, 211, 212, and 213 is “Above (indicating that the MV is equal to the MV of the above adjacent block as in the case shown in FIG. 2B)”.

Here, the four blocks 200, 201, 204, and 205 included in the upper left 8×8 partition are explained. The flags of the blocks 201 and 204 indicates that the current MVs are equal to the MV of the block 200. Moreover, the flag of the block 205 indicates that the current MV is equal to the MV of the block 201. In other words, it can be understood from the flags of the motion vectors that these four blocks 200, 201, 204, and 205 have the same MV. Therefore, the four blocks 200, 201, 204, and 205 included in the upper left 8×8 partition in FIG. 3A can be combined into a motion compensation block 301 having the partition size of 8×8 as shown in FIG. 3B.

Similarly, the four blocks 202, 203, 206, and 207 included in the upper right 8×8 partition in FIG. 3A can be combined into two motion compensation blocks 302 and 303 each having the partition size of 8×4 as shown in FIG. 3B.

Moreover, the four blocks 208, 209, 212, and 213 included in the lower left 8×8 partition in FIG. 3A can be combined into two motion compensation blocks 304 and 305 each having the partition size of 4×8 as shown in FIG. 3B.

Here, each of the four blocks 210, 211, 214, and 215 included in the lower right 8×8 partition in FIG. 3A has a different motion vector. On this account, these blocks cannot be combined and are processed as motion compensation blocks 306, 307, 308, and 309 each having the partition size of 4×4 as shown in FIG. 3B.

In the above, whether or not the adjacent blocks are combinable is determined based on the flags of the motion vectors of the blocks included in the 8×8 partition which is a unit of motion compensation. However, the partition size of the blocks to be compared is not particularly limited. For example, the flags may be compared on an 8×4 partition basis or on a 4×8 partition basis. Moreover, the flags of any adjacent blocks within a macroblock or in different macroblocks having a boundary in between may be compared. For example, the four blocks 209, 210, 213, and 214 each having the partition size of 4×4 in FIG. 3A have the same motion vector and, therefore, can be combined into a motion compensation block having the partition size of 8×8.

Furthermore, recursive combining can be performed. With this, after combining is performed once, whether or not the motion compensation blocks can be further combined is determined. For example, the combined motion compensation blocks 305, 306, and 308 shown in FIG. 3B have the same motion vector and, therefore, can be further combined into a motion compensation block having the partition size of 8×8.

Each of FIG. 3C, FIG. 3D, FIG. 3E, and FIG. 3F is a diagram showing another example of block combining according to Embodiment 1 of the present disclosure. FIG. 3C shows the case, as an example, where the partition size of each block included in one macroblock is 4×4. In FIG. 3C, a flag regarding a motion vector is described for each of the blocks.

To be more specific, each of the flags of blocks 220, 221, 222, 223, 225, 226, 227, 228, 229, 230, 231, 233, 234, and 235 is “Left”. Each of the flags of blocks 224 and 232 is “Above”.

Here, the four blocks 220, 221, 224, and 225 included in the upper left 8×8 partition are explained. It can be understood from the flags of the motion vectors that these four blocks 220, 221, 224, and 225 have the same MV. Therefore, the four blocks 220, 221, 224, and 225 included in the upper left 8×8 partition in FIG. 3C can be combined into a motion compensation block 321 having the partition size of 8×8 as shown in FIG. 3D.

Moreover, the four blocks 222, 223, 226, and 227 included in the upper right 8×8 partition in FIG. 3C can be combined into two motion compensation blocks 322 and 323 each having the partition size of 8×4 as shown in FIG. 3D. Here, each of the flags regarding the motion vectors of the motion compensation blocks 322 and 323 is “Left”.

The motion compensation block 321 having the partition size of 8×8 is on the left side of the motion compensation blocks 322 and 323. More specifically, the resulting motion vectors of the two motion compensation blocks 322 and 323 each having the partition size of 8×4 are equal to the motion vector of the motion compensation block 321 shown in FIG. 3D. Thus, the two motion compensation blocks 322 and 323 in FIG. 3D can be further combined into a motion compensation block 332 having the partition size of 8×8 as shown in FIG. 3E.

Moreover, the four blocks 228, 229, 232, 233 included in the lower left 8×8 partition in FIG. 3C can be combined into a motion compensation block 324 having the partition size of 8×8 as shown in FIG. 3D.

Furthermore, the four blocks 230, 231, 234, 235 included in the lower right 8×8 partition in FIG. 3C can be combined into two motion compensation blocks 325 and 326 each having the partition size of 8×4 as shown in FIG. 3D. Here, each of the flags regarding the motion vectors of the motion compensation blocks 325 and 326 is “Left”. The motion compensation block 324 having the partition size of 8×8 is on the left side of the motion compensation blocks 325 and 326.

More specifically, the resulting motion vectors of the two motion compensation blocks 325 and 326 each having the partition size of 8×4 are equal to the motion vector of the motion compensation block 324 shown in FIG. 3D. Thus, the two motion compensation blocks 325 and 326 in FIG. 3D can be further combined into a motion compensation block 334 having the partition size of 8×8 as shown in FIG. 3E.

Moreover, the combined motion compensation block 332 shown in FIG. 3E has the partition size of 8×8 and has the flag regarding the motion vector as “Left”. Here, the combined motion compensation block 331 having the partition size of 8×8 is on the left side of the motion compensation block 332. More specifically, these two motion compensation blocks 331 and 332 each having the partition size of 8×8 are equal in motion vector. Therefore, the two motion compensation blocks 331 and 332 shown in FIG. 3E can be further combined into a motion compensation block 341 having the partition size of 16×8 as shown in FIG. 3F.

Similarly, the combined motion compensation block 334 shown in FIG. 3E has the partition size of 8×8 and has the flag regarding the motion vector as “Left”. Here, the combined motion compensation block 333 having the partition size of 8×8 is on the left side of the motion compensation block 334. More specifically, these two motion compensation blocks 333 and 334 each having the partition size of 8×8 are equal in motion vector. Therefore, the two motion compensation blocks 333 and 334 shown in FIG. 3E can be further combined into a motion compensation block 342 having the partition size of 16×8 as shown in FIG. 3F.

As described, recursive combining is performed. With this, after the blocks are combined into motion compensation blocks once, whether or not the motion compensation blocks can be further combined is determined. As a result, the blocks having the same motion vector are combined into a motion compensation block having a larger partition size, and motion compensation can be performed for each of such motion compensation blocks. In the above, the flags regarding the motion vectors of the motion compensation blocks are compared on an 8×8 partition basis. However, the flags of the motion vectors of the motion compensation blocks in a 16×16 partition may be compared.

As described, the blocks having the same motion vector are combined into one motion compensation block having a larger partition size, and motion compensation can be performed for each of such motion compensation blocks.

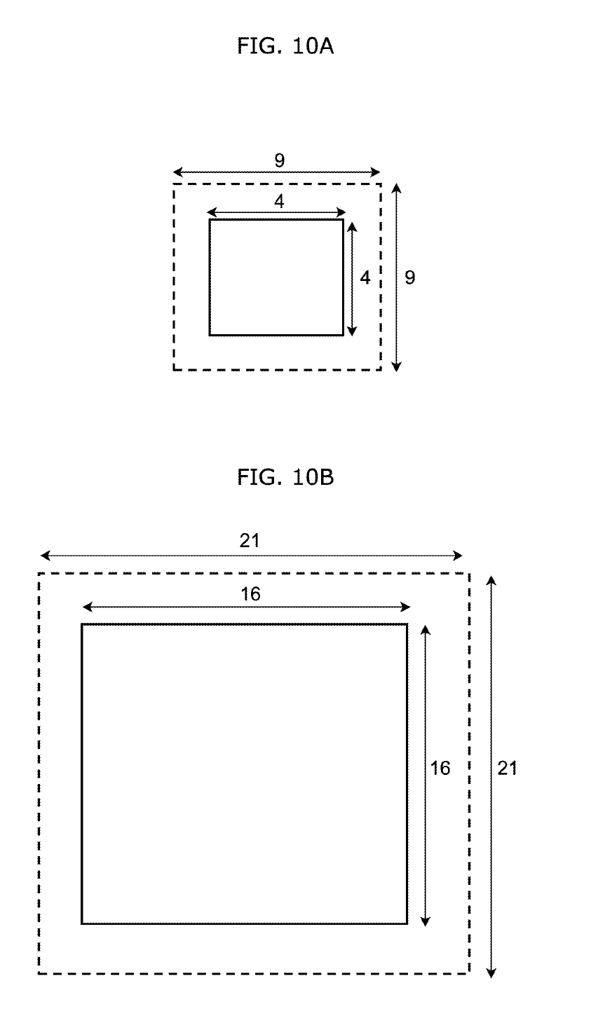

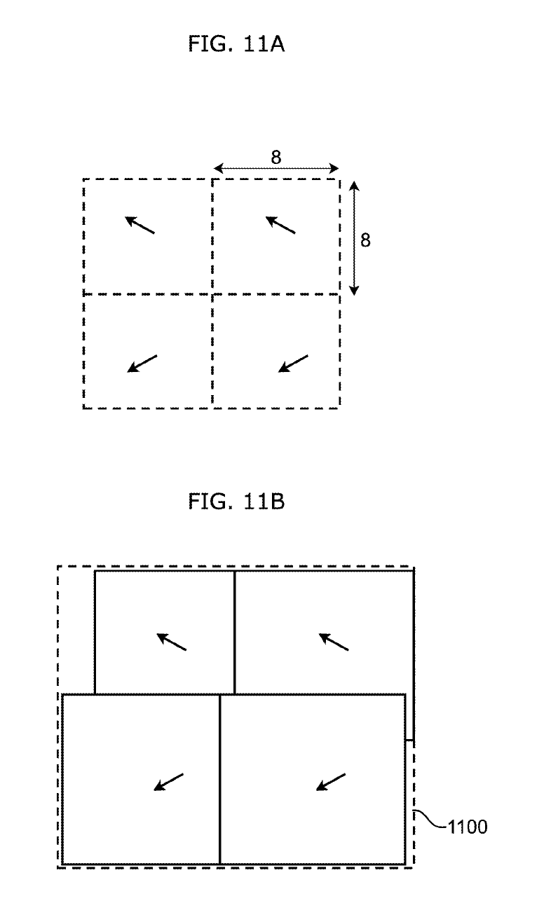

As the memory transfer size for obtaining a reference image from the buffer 160, reference image data corresponding to the size of 9×9 pixels as indicated by the dashed line in FIG. 10A is necessary when the 6-tap filter is employed in motion compensation performed on the block having the partition size of 4×4. Similarly, reference image data corresponding to the size of 21×21 pixels as indicated by the dashed line in FIG. 10B is necessary when the 6-tap filter is employed in motion compensation performed on the block having the partition size of 16×16.

Therefore, when the partition size of the motion compensation block is 16×16 for example, reference image data corresponding to the size of 21×21 pixels is necessary for one motion compensation block in order to generate the prediction image for the luminance component. In this case, the maximum amount of reference image data to be read for generating the prediction image (256 bytes) for the luminance component of one macroblock is 441 (bytes)=21 (pixels)*21 (pixels)*1 (the number of vectors), for each of the prediction directions.

On the other hand, when the partition size is 4×4, the reference image data corresponding to the size of 9×9 pixels needs to be read for one motion compensation block as shown in FIG. 10A. In this case, the maximum amount of reference image data to be read for generating the prediction image for the luminance component of one macroblock is 1296 (bytes)=9 (pixels)*9 (pixels)*16 (the number of vectors), for each of the prediction directions. Thus, it is understood that, as compared with the case of the 16×16 partition, the amount of data to be read increases. To be more specific, when the partition size of a motion compensation block increases, the memory transfer size for obtaining the reference image can be reduced.

The following explains about the amount of reference image data to be read in the case, as described with reference to FIG. 3A and FIG. 3B, where the four blocks 200, 201, 204, and 205 included in the upper left 8×8 partition shown in FIG. 3A are combined into the motion compensation block 301 having the partition size of 8×8 shown in FIG. 3B.

When each partition size of the four motion compensation blocks before combining is 4×4, the reference image data corresponding to the size of 9×9 pixels needs to be read for each of the motion compensation blocks having the partition size of 4×4. In this case, the maximum amount of data to be read as the reference image data necessary for generating the prediction image for the luminance component of the 8×8 partition (including the four 4×4 motion compensation blocks) is 324 (bytes)=9 (pixels)*9 (pixels)*4 (the number of vectors (i.e., the number of motion compensation blocks)).

Moreover, when the partition size of the combined motion compensation block is 8×8, the reference image data corresponding to the size of 13×13 pixels needs to be read. In this case, the maximum amount of data to be read as the reference image data necessary for generating the prediction image for the luminance component of the 8×8 partition is 169 (bytes)=13 (pixels)*13 (pixels)*1 (the number of vectors (i.e., the number of motion compensation blocks)). It is understood that, as compared with the case before combining, the amount of data to be read can be reduced. To be more specific, the memory transfer size for obtaining the reference image can be reduced by combining the motion compensation blocks.

Furthermore, it can be understood that the memory transfer size for the combined motion compensation block having the partition size of 8×8 is the same as in the case of the original motion compensation block having the partition size of 8×8. In this case, when the motion vectors are equal to each other, a data transfer sequence and an access sequence (such as an address, a control command, and a control signal for an SDRAM) for reading the aforementioned reference image data of the luminance component from the buffer 160 (the external memory such as an SDR-SDRAM, a DDR-SDRAM, a DDR2-SDRAM, or a DDR3-SDRAM) are the same. It should be noted here that the amount of data to be read as the reference image data of the luminance component and the access time may increase depending on, for example, a bus width of a bus connected to the external memory, the amount of data per access, and AC characteristics of the external memory (such as a CAS latency and a wait cycle of the SDRAM). Moreover, note that the operation of reading the aforementioned reference image data of the luminance component from the buffer 160 may be interrupted by, for example, a different access operation (such as an operation of reading reference data of a chrominance component corresponding to the current motion compensation block, an operation of reading and outputting the image data to the display unit, and access from a CPU).

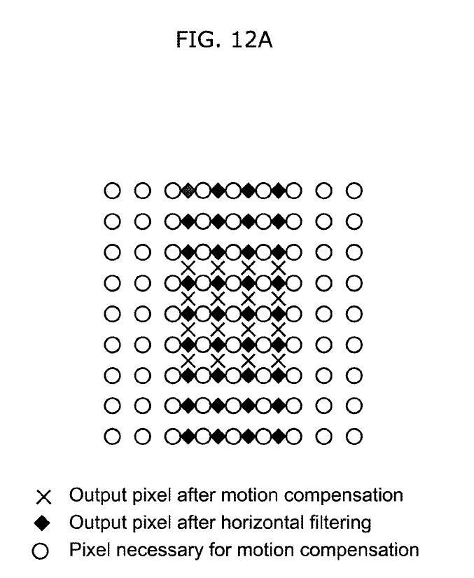

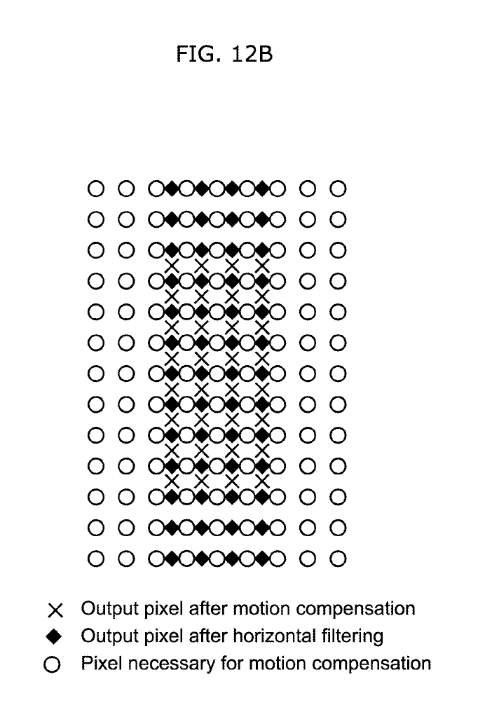

Furthermore, suppose that the throughput in motion compensation is equivalent to the number of output pixels including intermediate pixels, as shown in FIG. 12A and FIG. 12B. Also suppose here the case where the prediction image for the luminance component of one macroblock (256 bytes) is to be generated. In this case, when the motion compensation block has the partition size of 4×4, the number of times (throughput) 6-tap filtering needs to be performed for one motion compensation block is: 36 times (indicated by the filled squares in FIG. 12A)=4 (pixels)*9 (pixels) in horizontal filtering; and 16 times (indicated by the crosses in FIG. 12A)=4 (pixels)*4 (pixels) in vertical filtering. In other words, 6-tap filtering needs to be performed 832 times=(36+16)*16 (the number of partitions) for one macroblock.

On the other hand, when the motion compensation block has the partition size of 4×8, horizontal filtering needs to be performed 52 times (indicated by the filled squares in FIG. 12B)=4 (pixels)*13 (pixels) for one motion compensation block; and vertical filtering needs to be performed 32 times (indicated by the crosses in FIG. 12B)=4 (pixels)*8 (pixels) for one motion compensation block. In other words, 6-tap filtering needs to be performed 672 times=(52+32)*8 (the number of partitions) for one macroblock. Thus, the number of times filtering needs to be performed in the case where the partition size is 4×8 is reduced as compared with the case where the partition size is 4×4.

Similarly, when the motion compensation block has the partition size of 16×16, horizontal filtering needs to be performed 336 times=16 (pixels)*21 (pixels) for one motion compensation block; and vertical filtering needs to be performed 256 times=16 (pixels)*16 (pixels) for one motion compensation block. In other words, 6-tap filtering needs to be performed 592 times=(336+256)*1 (the number of partitions) for one macroblock. Thus, the number of times filtering needs to be performed is further reduced.

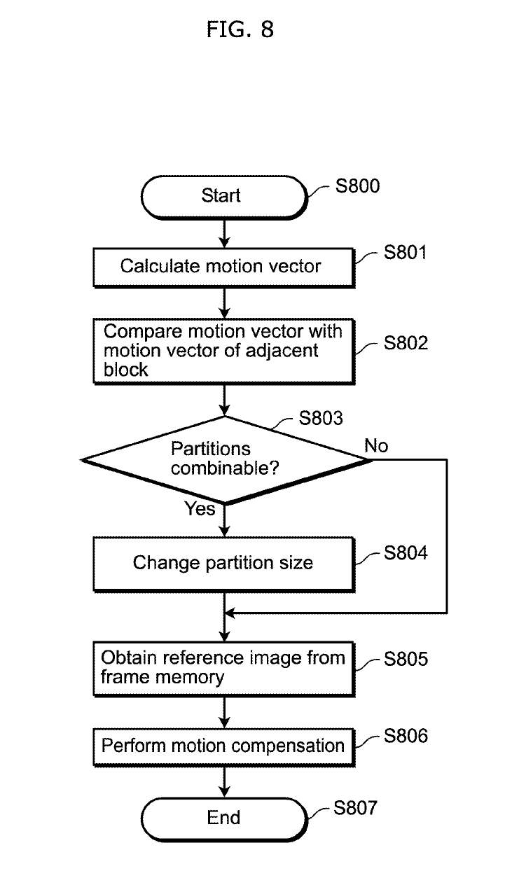

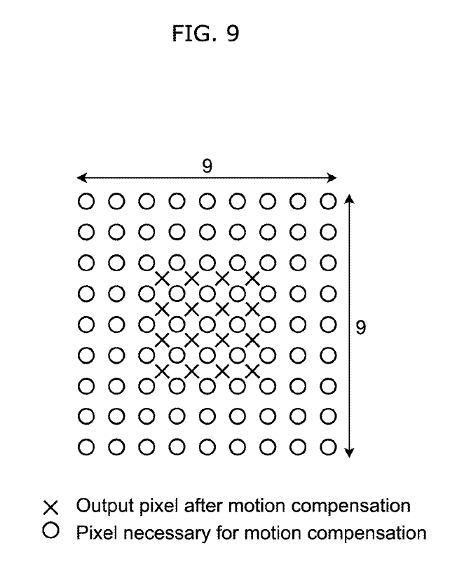

Here, processing performance can be increased by a circuit having a configuration whereby a plurality of pixels can be outputted at one time in the horizontal or vertical direction through filtering. For example, when the partition size is 4×4 (as in FIG. 12A) and 8 pixels can be outputted at the same time through 6-tap filtering, horizontal filtering may be performed 9 times and vertical filtering may be performed 4 times. More specifically, the number of times filtering is performed is 208 times=(9+4)*16 (the number of partitions) for one macroblock. When the partition size is 4×8 (as in FIG. 12B), horizontal filtering may be performed 13 times and vertical filtering may be performed 4 times. More specifically, the number of times filtering is performed is 136 times=(13+4)*8 (the number of partitions) for one macroblock.

To be more specific, when the partition size of the motion compensation block increases, the number of times filtering needs to be performed (the throughput) can be reduced. As a result, the number of pixels to be read as the reference image data from the buffer 160 can be reduced, and thus motion compensation can be performed at high speed with low power consumption.

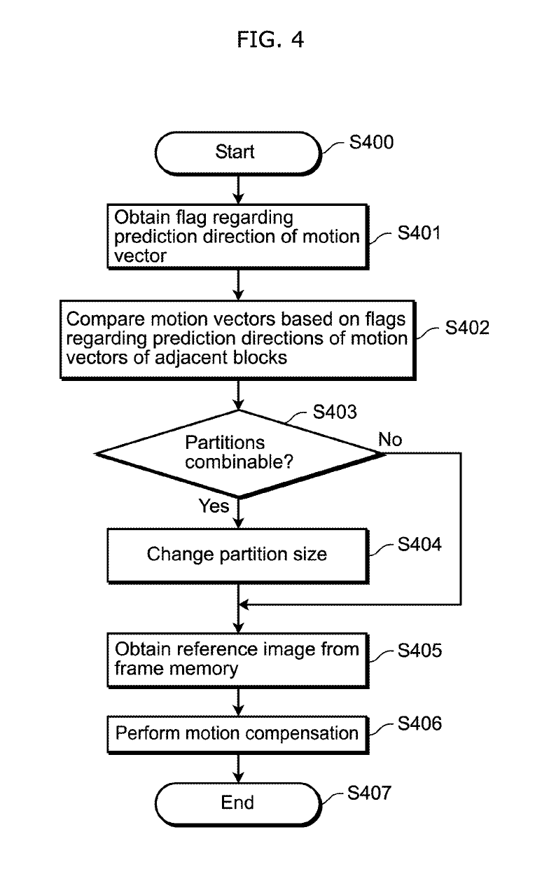

FIG. 4 is a flowchart of prediction image generation according to Embodiment 1 of the present disclosure.

Firstly, the decoding unit 110 obtains a flag regarding a motion vector from an encoded video stream and outputs the flag to the motion vector comparing unit 120 (Step S401).

Next, based on the input flag regarding the motion vector and the previously-obtained flags regarding the motion vectors of the adjacent blocks, the motion vector comparing unit 120 determines whether or not the adjacent blocks are equal in motion vector and outputs the result to the block combining unit 130 (Step S402).

After this, when it is determined that the adjacent blocks are combinable (namely, when the blocks are equal in motion vector in Step S402) (Yes in Step S403), the block combining unit 130 changes the blocks that are equal in motion vector into a motion compensation block having one partition size (Step S404).

Then, the motion vector generating unit 140 calculates a motion vector and outputs the motion vector to the frame memory transfer control unit 150. It should be noted that the motion vector generating unit 140 may calculate a motion vector for each motion compensation block. To be more specific, it is only necessary for the motion vector generating unit 140 to calculate a motion vector of one block among the blocks included in the motion compensation block.

The frame memory transfer control unit 150 obtains, from the buffer 160, a reference image region indicated by the motion vector, that is, reference image data necessary for motion compensation to be performed on the motion compensation block, and then transfers the reference image data to the local reference memory 170 (Step S405).

The motion compensating unit 180 performs motion compensation for each motion compensation block using the reference image data obtained from the local reference memory 170, and outputs the generated prediction image to the adder 190 (Step S406).

When it is determined that the adjacent blocks are not combinable in Step S403, the partition size is not changed. Thus, reference image data is obtained and motion compensation is performed, for each motion compensation block having the original partition size (Steps S405 and S406).

In the flowchart shown in FIG. 4, whether or not the comparison target blocks are combinable may be determined on an 8×8 partition basis, based on the flags regarding the motion vectors of these blocks included in this partition. Alternatively, the determination may be made on a different partition basis (for example, on a 16×16, 16×8, 8×16, 8×4, or 4×8 basis). It should be obvious that when the partition size of the current block is larger than the size of the block to be compared therewith to determine whether these blocks are combinable, the partition size is not changed. Thus, reference image data is obtained and motion compensation is performed, for each motion compensation block having the original partition size

According to the processing shown in FIG. 4, the blocks having the same motion vector are combined and thus motion compensation can be performed on the combined motion compensation block having a larger partition size. As a result, the memory transfer size for obtaining the reference image data can be reduced, and the throughput in motion compensation can also be reduced. Hence, the number of pixels to be read as the reference image data from the buffer 160 can be reduced, and thus motion compensation can be performed at high speed with low power consumption.

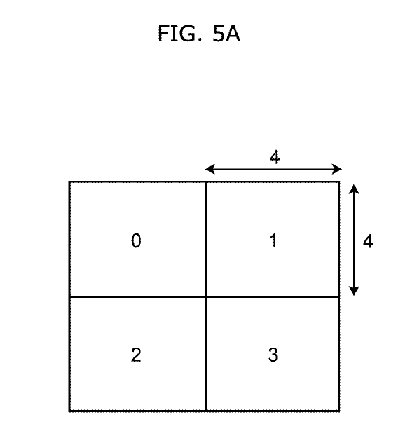

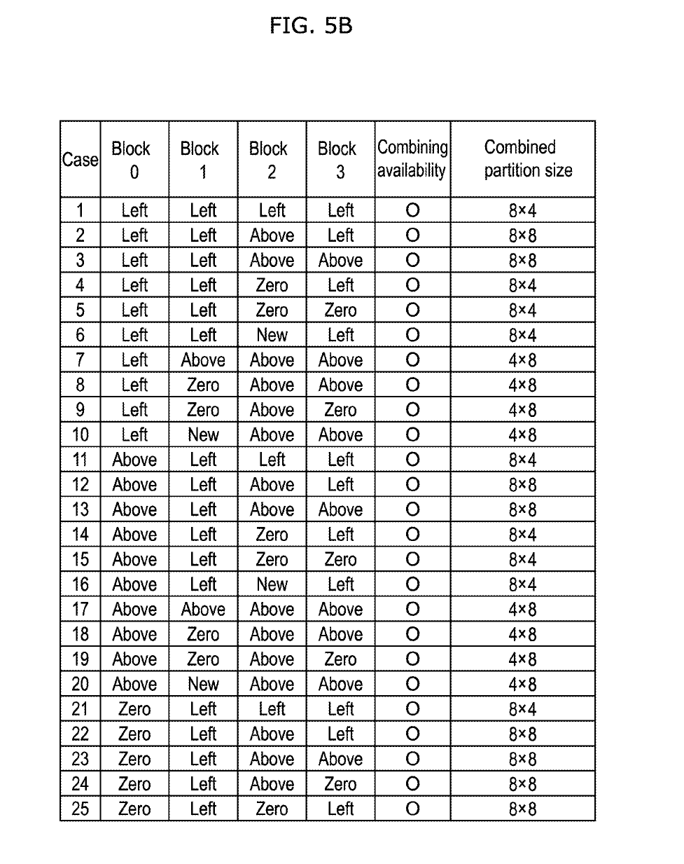

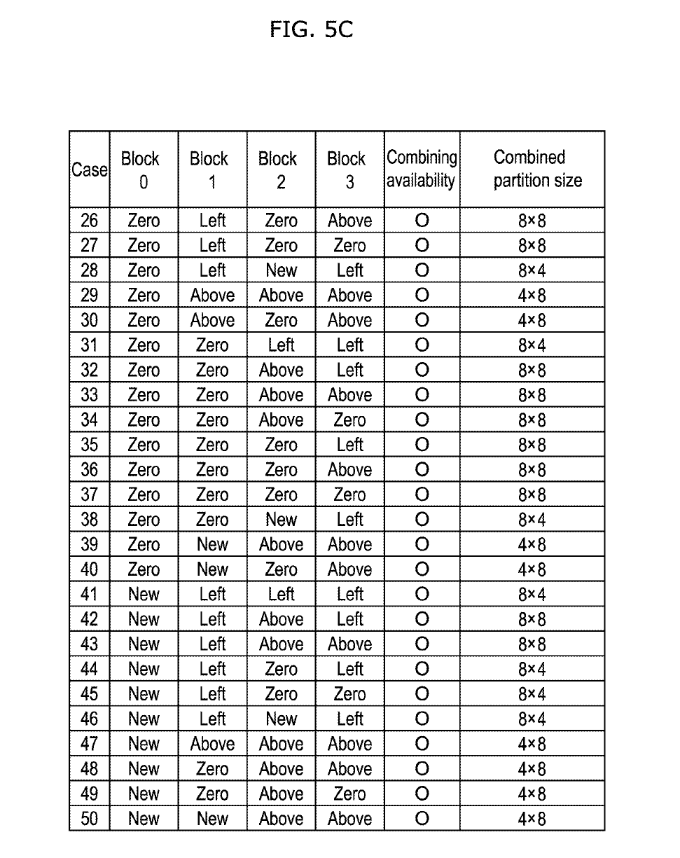

Each of FIG. 5A, FIG. 5B, and FIG. 5C shows an example where four blocks included in an 8×8 partition are determined as being combinable based on the flags regarding the motion vectors.

FIG. 5A is a diagram showing a positional relationship of the four blocks each having the partition size of 4×4. The upper left block is represented by “0”. The upper right block is represented by “1”. The lower left block is represented by “2”. The lower right block is represented by “3”.

Each of FIG. 5B and FIG. 5C is a diagram showing an example of combinations of flags based on which the four blocks 0, 1, 2, and 3 included in the 8×8 partition shown in FIG. 5A are determined as being combinable. Moreover, each of FIG. 5B and FIG. 5C shows the combined partition size for each case.

For example, Case 43 shown in FIG. 5C indicates the case of the upper left four blocks 200, 201, 204, and 205 shown in FIG. 3A. In this case, the diagram indicates that these blocks are combinable into a motion compensation block having the partition size of 8×8.

In this way, when the flags regarding the motion vectors of the four blocks included in the 8×8 partition are compared on an 8×8 partition basis, the comparison processing can be simplified by employing the result of comparison shown in FIG. 5B or FIG. 5C. Moreover, the result may be employed by a comparison circuit. With this, a video decoding apparatus and a video decoding circuit can be implemented by a relatively simple circuit.

In addition to the examples shown in FIG. 5B and FIG. 5C, the blocks included in the 8×8 partition may be combined into one motion compensation block having the partition size of 8×4 and two motion compensation blocks each having the partition size of 4×4. Moreover, the flags of the blocks included in a 16×16 macroblock may be compared. Furthermore, the flags of the blocks included in a partition having the size of, for example, 16×8 or 8×16 may be compared.

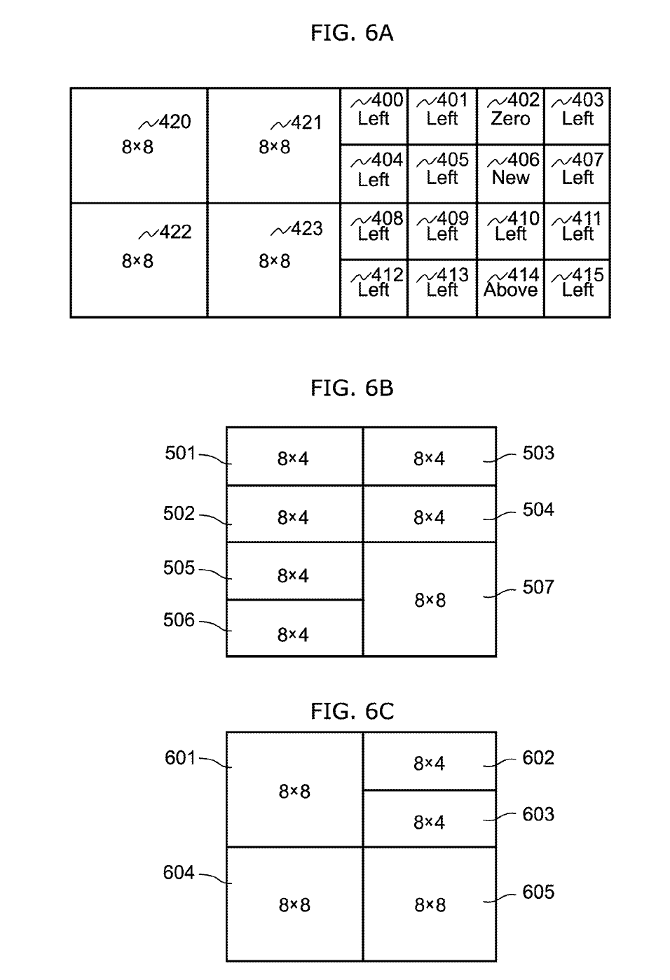

Each of FIG. 6A to FIG. 6C is a diagram showing an example of block combining according to Embodiment 1 of the present disclosure. In FIG. 6A, the partition size of each block included in one macroblock is 4×4, and the partition size of each block included in an adjacent macroblock is 8×8.

In the macroblock including the blocks having the partition size of 4×4, a flag regarding a motion vector is described for each of the blocks. Moreover, four blocks 420, 421, 422, and 423 each having the partition size of 8×8 on the left side in the diagram are, for example, motion compensation blocks previously combined by the block combining unit 130.

To be more specific, the flag of a block 406 is “New (indicating that the MV is separately present as in the case shown in FIG. 2D)”. Moreover, each of the flags of blocks 400, 401, 403, 404, 405, 407, 408, 409, 410, 411, 412, 413, and 415 is “Left (indicating that the MV is equal to the MV of the left adjacent block as in the case shown in FIG. 2A)”. Furthermore, the flag of a block 402 is “Zero (indicating that the MV is 0 as in the case shown in FIG. 2C)”. Moreover, the flag of a block 414 is “Above (indicating that the MV is equal to the MV of the above adjacent block as in the case shown in FIG. 2B)”.

Here, the four blocks 400, 401, 404, and 405 included in the upper left 8×8 partition are explained. The blocks 400 and 401 have the same MV and the blocks 404 and 405 have the same MV, as can be seen from the flags regarding the motion vectors (“Left” in this case) shown in FIG. 6A. Therefore, the four blocks 400, 401, 404, and 405, shown in FIG. 6A, each having the partition size of 4×4 can be combined into two motion compensation blocs 501 and 502 each having the partition size of 8×4 as shown in FIG. 6B.

Similarly, the four blocks 402, 403, 406, and 407 included in the upper right 8×8 partition in FIG. 6A can be combined into two motion compensation blocks 503 and 504 each having the partition size of 8×4 as shown in FIG. 6B.

Moreover, the four blocks 408, 409, 412, and 413 included in the lower left 8×8 partition in FIG. 6A can be combined into two motion compensation blocks 505 and 506 each having the partition size of 8×4 as shown in FIG. 6B.

Furthermore, the four blocks 410, 411, 414, and 415 included in the lower right 8×8 partition in FIG. 6A can be combined into one motion compensation block 507 having the partition size of 8×8 as shown in FIG. 6B.

Moreover, the blocks included in the upper left 8×8 partition in FIG. 6A are combined into the two motion compensation blocks 501 and 502 each having the partition size of 8×4 as shown in FIG. 6B. Here, each of the flags regarding the motion vectors of the motion compensation blocks 501 and 502 is “Left”. The block 421 having the partition size of 8×8 in the adjacent macroblock is on the left side of the motion compensation blocks 501 and 502.

More specifically, the resulting motion vectors of the two motion compensation blocks 501 and 502 each having the partition size of 8×4 are equal to the motion vector of the block 421 shown in FIG. 6A. Thus, the two motion compensation blocks 501 and 502 in FIG. 6B can be further combined into a motion compensation block 601 having the partition size of 8×8 as shown in FIG. 6C.

As described, when each of the motion vectors of the two comparison target blocks (the motion compensation blocks 501 and 502 in the above example) is equal to the motion vector of the block (the block 421 in the above example) that is adjacent to these two blocks and has the partition size larger than the partition size of these two blocks, these two blocks can be combined into one motion compensation block (the motion compensation block 601 in the above example).

Similarly, each of the flags regarding the motion vectors of the two motion compensation blocks 505 and 506 included in the lower left 8×8 partition shown in FIG. 6B is “Left”. The block 423 having the partition size of 8×8 in the adjacent macroblock is on the left side of the motion compensation blocks 505 and 506.

More specifically, the resulting motion vectors of the two motion compensation blocks 505 and 506 each having the partition size of 8×4 are equal to the motion vector of the block 423 shown in FIG. 6A. Thus, the two motion compensation blocks 505 and 506 in FIG. 6B can be further combined into a motion compensation block 604 having the partition size of 8×8 as shown in FIG. 6C.

As described above, a comparison can be made not only within one macroblock but with an adjacent macroblock. As a result, the adjacent motion compensation blocks can be further combined.

Moreover, a combined motion compensation block 605 shown in FIG. 6C is in the partition size of 8×8 and has the flag regarding a motion vector indicated as “Left”. The combined motion compensation block 604 having the partition size of 8×8 is on the left side of this motion compensation block 605. More specifically, the two motion compensation blocks 604 and 605 each having the partition size of 8×8 are equal in motion vector. Thus, the two motion compensation blocks 604 and 605 can be further combined into a motion compensation block having the partition size of 16×8.

The above describes the case where the partition size of the block included in the adjacent macroblock is 8×8. However, even when the motion compensation block included in the adjacent macroblock is 16×16, 8×16, or 16×8 in size or is an intra macroblock (such as when the motion vector is processed as 0), the resulting combined motion compensation block is in the same size as described above.

As described, the blocks having the same motion vector are combined and thus motion compensation can be performed on the combined motion compensation block having a larger partition size. As a result, the memory transfer size for obtaining the reference image data can be reduced, and the throughput in motion compensation can also be reduced. Hence, the number of pixels to be read as the reference image data from the buffer 160 can be reduced, and thus motion compensation can be performed at high speed with low power consumption.

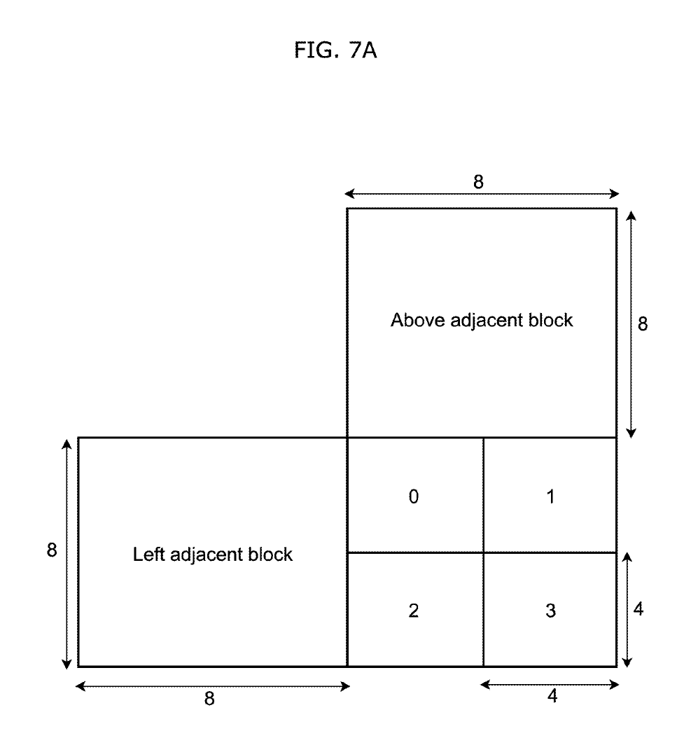

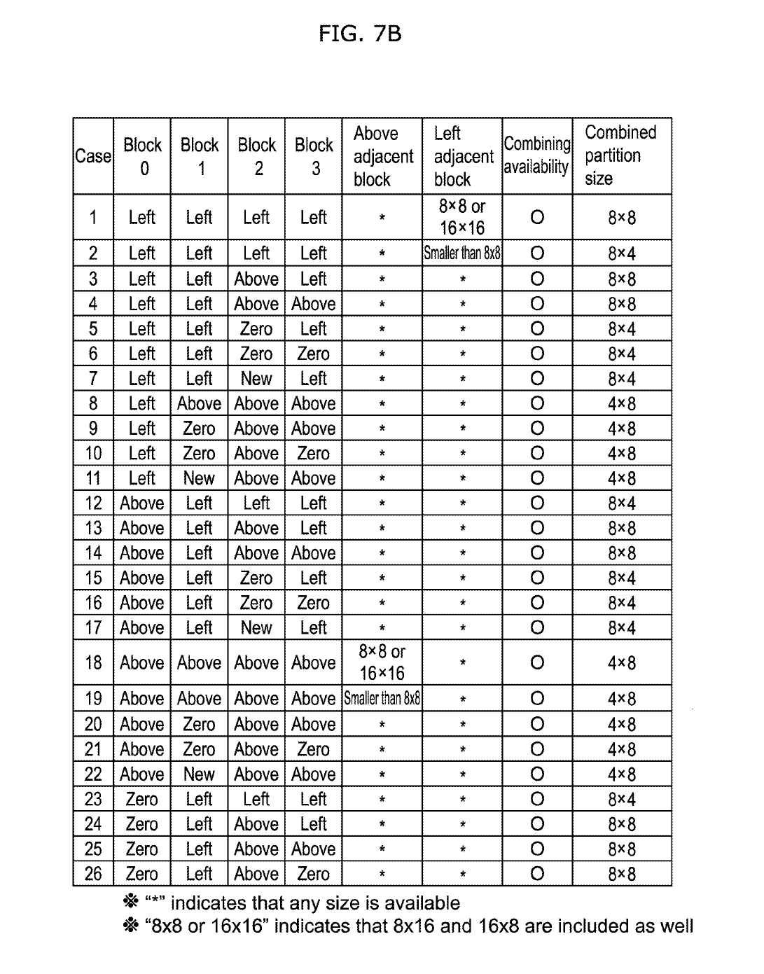

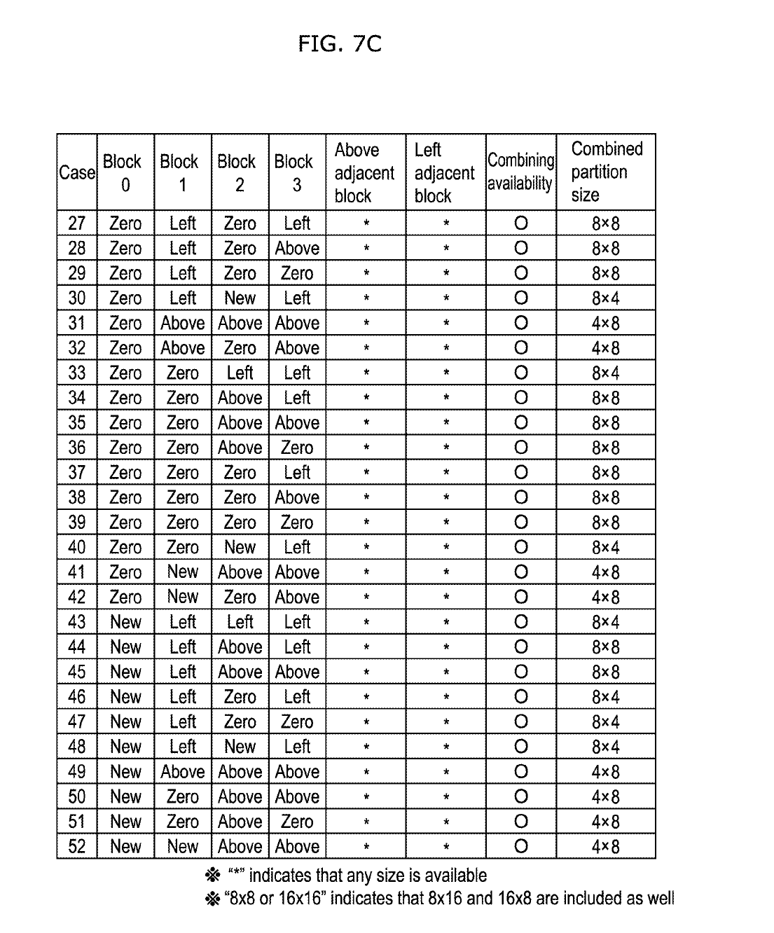

Next, each of FIG. 7A, FIG. 7B, and FIG. 7C shows an example where motion vectors are compared based on the flags regarding the motion vectors of four blocks included in an 8×8 partition and in consideration of the above adjacent block and the left adjacent block.

FIG. 7A is a diagram showing a positional relationship of the adjacent four blocks each having the partition size of 4×4. The upper left block is represented by “0”. The upper right block is represented by “1”. The lower left block is represented by “2”. The lower right block is represented by “3”. Moreover, FIG. 7A shows the positions of the above adjacent block (described as “Above adjacent block”) and the left adjacent block (described as “Left adjacent block”).

Each of FIG. 7B and FIG. 7C is a diagram showing an example of combinations of flags based on which the four blocks 0, 1, 2, and 3 included in the 8×8 partition and the above and left adjacent blocks each having the partition size of 8×8 as shown in FIG. 7A are determined as being combinable. Moreover, each of FIG. 7B and FIG. 7C shows the combined partition size for each case.

For example, Case 1 shown in FIG. 7B indicates the case of the four blocks 400, 401, 404, and 405 included in the upper left 8×8 partition in FIG. 6A. In this case, the diagram indicates that these blocks are combinable into a motion compensation block having the partition size of 8×8.

In this way, when the flags regarding the motion vectors of the four blocks included in the 8×8 partition are compared on an 8×8 partition basis, the comparison processing can be simplified by employing the result of comparison shown in FIG. 7B or FIG. 7C. Moreover, the result may be employed by a comparison circuit. With this, a video decoding apparatus and a video decoding circuit can be implemented by a relatively simple circuit.

In addition to the examples shown in FIG. 7B and FIG. 7C, the blocks included in the 8×8 partition may be combined into one motion compensation block having the partition size of 8×4 and two motion compensation blocks each having the partition size of 4×4. Moreover, the flags of the blocks included in a 16×16 macroblock may be compared. Furthermore, the flags of the blocks included in a partition having the size of, for example, 16×8 or 8×16 may be compared.

### Embodiment 2

The following describes a video decoding apparatus according to Embodiment 2 of the present disclosure. The video decoding apparatus according to Embodiment 2 is different from the video decoding apparatus according to Embodiment 1 in that motion vectors of adjacent blocks are compared by actually calculating a motion vector for each block without using a flag regarding a motion vector. It should be noted that detailed descriptions of points common to Embodiment 1 and Embodiment 2 are not repeated here and that only different points are thus mainly described.

FIG. 8 is a flowchart of prediction image generation according to Embodiment 2 of the present disclosure.

Firstly, a decoding unit 110 obtains a motion vector or a difference value of a prediction motion vector from an encoded video stream, and outputs the motion vector or the difference value to a motion vector generating unit 140. The motion vector generating unit 140 calculates a motion vector from the received motion vector or difference value and the prediction motion vector, and outputs the result to a motion vector comparing unit 120 (Step S801).

Next, the motion vector comparing unit 120 compares the motion vector received from the motion vector generating unit 140 with motion vectors of adjacent blocks to determine whether or not the adjacent blocks are equal in motion vector, and outputs the result of the determination to a block combining unit 130 (Step S802).

Then, when it is determined that the blocks are combinable (that is, the blocks are equal in motion vector in Step S802) (Yes in Step S803), the block combining unit 130 combines the blocks equal in motion vector into one motion compensation block having a large partition size and outputs the result to the motion vector generating unit 140 (Step S804).

After this, the motion vector generating unit 140 calculates a motion vector of the motion compensation block and outputs the calculated motion vector to a frame memory transfer control unit 150. It should be noted that the motion vector calculated in Step S801 may be used here.

Then, the frame memory transfer control unit 150 obtains, from a buffer 160 based on the result achieved by the block combining unit 130, a reference image region indicated by the motion vector, that is, reference image data necessary for motion compensation to be performed on the motion compensation block, and then transfers the reference image data to a local reference memory 170 (Step S805).

A motion compensating unit 180 performs motion compensation on the motion compensation block using the reference image data obtained from the local reference memory 170, and outputs the generated prediction image to an adder 190 (Step S806).

When it is determined that the adjacent blocks are not combinable in Step S803, the partition size is not changed. Thus, reference image data is obtained and motion compensation is performed, for each motion compensation block having the original partition size (Steps S805 and S806).

In the flowchart shown in FIG. 8, whether or not the comparison target blocks are combinable may be determined on an 8×8 partition basis, based on the motion vectors of these blocks included in this partition. Alternatively, the determination may be made on a different partition basis (for example, on a 16×16, 16×8, 8×16, 8×4, or 4×8 basis). It should be obvious that when the partition size of the current block is larger than the size of the block to be compared therewith to determine whether these blocks are combinable, the partition size is not changed. Thus, reference image data is obtained and motion compensation is performed, for each motion compensation block having the original partition size

According to the processing shown in FIG. 8, the blocks having the same motion vector are combined and thus motion compensation can be performed on the combined motion compensation block having a larger partition size. As a result, the memory transfer size for obtaining the reference image data can be reduced, and the throughput in motion compensation can also be reduced. Hence, the number of pixels to be read as the reference image data from the buffer 160 can be reduced, and thus motion compensation can be performed at high speed with low power consumption.

### Other Embodiments

In Embodiment 1 and Embodiment 2, the diagrams showing the configurations are described. However, these embodiments are not intended to be limiting. The configuration may be implemented as a single Large Scale Integrated (LSI) chip or individual LSI chips. In the future, with advancement in semiconductor technology, a brand-new technology may replace LSI. The functional blocks can be integrated using such a technology. The possibility is that the present disclosure is applied to biotechnology. Moreover, the present disclosure may be implemented as a program to be executed on a computer.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The video decoding apparatus in the present disclosure is useful as a video decoding apparatus for decoding an encoded video stream encoded using motion estimation and as a video reproducing method. Moreover, the video decoding apparatus in the present disclosure is also applicable to, for example, a DVD recorder, a DVD player, a Blu-ray disc recorder, a Blu-ray disc player, a digital TV, and a mobile data terminal such as a smartphone.

1. A video decoding apparatus which decodes an encoded video stream encoded using motion estimation performed on a block-by-block basis, the video decoding apparatus comprising:
a decoding unit configured to decode the encoded video stream to derive a flag regarding a motion vector, the flag indicating one of (i) a prediction direction indicating that the motion vector is equal to a motion vector of an adjacent block, (ii) that the motion vector is 0, and (iii) that difference information on the motion vector is encoded in the encoded video stream;
a motion vector comparing unit configured to determine whether or not a plurality of the motion vectors of adjacent blocks are equal to each other, using a plurality of the flags regarding the motion vectors of the adjacent blocks, the flags being derived by the decoding unit;
a block combining unit configured to combine the adjacent blocks determined by the motion vector comparing unit as being equal in motion vector, into one motion compensation block on which motion compensation is to be performed;
a motion vector generating unit configured to generate a motion vector based on the flag regarding the motion vector;
a reference image obtaining unit configured to obtain, based on the motion vector generated by the motion vector generating unit, a reference image corresponding to the motion compensation block from reference image data previously decoded and stored into a memory;
a motion compensating unit configured to perform motion compensation using the reference image obtained by the reference image obtaining unit, to generate a prediction image corresponding to the motion compensation block; and
a reconstructing unit configured to reconstruct an image using the prediction image generated by the motion compensating unit.

2. The video decoding apparatus according to claim 1,
wherein the block combining unit is configured to set a motion compensation block determined by the motion vector comparing unit as being different from the adjacent block in motion vector, as an independent motion compensation block.

3. The video decoding apparatus according to claim 1,
wherein the prediction direction indicated by the flag regarding the motion vector indicates that a block associated with the flag is equal in motion vector to an above adjacent block or a left adjacent block.

4. The video decoding apparatus according to claim 1,
wherein each of the blocks to be compared by the motion vector comparing unit and each of the blocks to be combined by the block combining unit is 4 pixels by 4 pixels or 8 pixels by 8 pixels in size.

5. The video decoding apparatus according to claim 1,
wherein the blocks to be compared by the motion vector comparing unit are included in the same macroblock.

6. The video decoding apparatus according to claim 5,
wherein the motion vector comparing unit is configured to determine, for each of the blocks, whether or not the block is equal in motion vector to an above adjacent block, a left adjacent block, or an upper-left adjacent block.

7. The video decoding apparatus according to claim 5,
wherein, when the flags regarding the motion vectors of two adjacent blocks to be compared by the motion vector comparing unit indicate that the two blocks are equal in motion vector to a motion compensation block included in a macroblock adjacent to the two blocks, the motion vector comparing unit is configured to determine that the motion vectors of the two blocks are equal to each other.

8. The video decoding apparatus according to claim 7,
wherein the motion compensation block included in the macroblock adjacent to the two blocks is 16 pixels by 16 pixels or 8 pixels by 8 pixels in size.

9. The video decoding apparatus according to claim 1,
wherein the encoded video stream is encoded according to VP8.

10. A video decoding apparatus which decodes an encoded video stream encoded using motion estimation performed on a block-by-block basis, the video decoding apparatus comprising:
a decoding unit configured to decode a difference value of a motion vector from the encoded video stream;
a vector predictor calculating unit configured to calculate a vector predictor indicating a prediction value of the motion vector;
a motion vector generating unit configured to generate a motion vector by adding the vector predictor calculated by the vector predictor calculating unit to the difference value of the motion vector decoded by the decoding unit;
a motion vector comparing unit configured to compare the motion vector generated by the motion vector generating unit with motion vectors of adjacent blocks to determine whether or not the motion vector is equal to the motion vectors of the adjacent blocks;
a block combining unit configured to combine the blocks determined by the motion vector comparing unit as being equal in motion vector, into one motion compensation block on which motion compensation is to be performed;
a reference image obtaining unit configured to obtain, based on the motion vector generated by the motion vector generating unit, a reference image corresponding to the motion compensation block from reference image data previously decoded and stored into a memory;
a motion compensating unit configured to perform motion compensation using the reference image obtained by the reference image obtaining unit, to generate a prediction image corresponding to the motion compensation block; and
a reconstructing unit configured to reconstruct an image using the prediction image generated by the motion compensating unit.

11. A video decoding method of decoding an encoded video stream encoded using motion estimation performed on a block-by-block basis, the video decoding method comprising:
decoding the encoded video stream to derive a flag regarding a motion vector, the flag indicating one of (i) a prediction direction indicating that the motion vector is equal to a motion vector of an adjacent block, (ii) that the motion vector is 0, and (iii) that difference information on the motion vector is encoded in the encoded video stream;
determining whether or not a plurality of the motion vectors of adjacent blocks are equal to each other, using a plurality of the flags regarding the motion vectors of the adjacent blocks, the flags being derived in the decoding;
combining the adjacent blocks determined in the comparing as being equal in motion vector, into one motion compensation block on which motion compensation is to be performed;
generating a motion vector based on the flag regarding the motion vector;
obtaining, based on the motion vector generated in the generating, a reference image corresponding to the motion compensation block from reference image data previously decoded and stored into a memory;
performing motion compensation using the reference image obtained in the obtaining, to generate a prediction image corresponding to the motion compensation block; and
reconstructing an image using the prediction image generated in the performing.

12. An integrated circuit which decodes an encoded video stream encoded using motion estimation performed on a block-by-block basis, the integrated circuit comprising:
a decoding unit configured to decode the encoded video stream to derive a flag regarding a motion vector, the flag indicating one of (i) a prediction direction indicating that the motion vector is equal to a motion vector of an adjacent block, (ii) that the motion vector is 0, and (iii) that difference information on the motion vector is encoded in the encoded video stream;
a motion vector comparing unit configured to determine whether or not a plurality of the motion vectors of adjacent blocks are equal to each other, using a plurality of the flags regarding the motion vectors of the adjacent blocks, the flags being derived by the decoding unit;
a block combining unit configured to combine the adjacent blocks determined by the motion vector comparing unit as being equal in motion vector, into one motion compensation block on which motion compensation is to be performed;
a motion vector generating unit configured to generate a motion vector based on the flag regarding the motion vector;
a reference image obtaining unit configured to obtain, based on the motion vector generated by the motion vector generating unit, a reference image corresponding to the motion compensation block from reference image data previously decoded and stored into a memory;
a motion compensating unit configured to perform motion compensation using the reference image obtained by the reference image obtaining unit, to generate a prediction image corresponding to the motion compensation block; and
a reconstructing unit configured to reconstruct an image using the prediction image generated by the motion compensating unit.
